(19) United States
(12) Patent Application Publication
(10) Pub. No.: US 2004/0238321 A1
(43) Pub. Date: Dec. 2, 2004

(54) Coin selector and an outer setting apparatus thereof

(76) Inventor: Hiroshi Otomo, Iwatsuki-shi (JP)

Correspondence Address: MCGLEW & TUTTLE, PC, 1 SCARBOROUGH STATION PLAZA, SCARBOROUGH, NY, 10510-0827, US

(21) Appl. No.: 10/848,705

(22) Filed: May 19, 2004

(30) Foreign Application Priority Data
May 26, 2003 (JP) JP 2003-148245

(51) Int. Cl. G07D 7/00; G07F 1/00

(52) U.S. Cl. 194/351; 194/302

(57) ABSTRACT

The first purpose is to provide a coin selector which can be easily set up the standard data without putting coins into the coin selector. The second purpose of this invention is to provide both a coin selector and a outside setting unit which are not easily changed in the standard data. A coin selector comprises of; plural standard data memory for memorizing standard data, a selecting means which can be effective a selected standard data memory based on a direction from an outside setting unit, a distinguishing means which compares the memorized data of said selected standard data memory and the outputting data of a coin sensor and outputs an authenticity signal, a gate controlling means which controls a gate based on an output from the distinguishing means.

### CROSS REFERENCE TO RELATED APPLICATIONS

This application claims the benefit of priority under 35 U.S.C. § 119 of Japan Patent Application No. 2003-148245 filed May 26, 2003, the entire contents of which are incorporated herein by reference.

### FIELD OF THE INVENTION

This invention is related to a coin selector for distinguishing the authenticity of coins. The invention is particularly related to a coin selector which can be set up easily and surely as to permissible values for use in discriminating among coins such as upper limit values and lower limit values which define a permissible range for each coin or coin standard data for distinguishing coins. Furthermore, the standard data can be changed by only a limited number of people, to prevent theft. In this specification, the term “coin” includes coins, tokens, discs, etc.

### BACKGROUND OF THE INVENTION

This present applicant suggested in the past that one cannot easily change such coin standard data easily e.g.; distinguishing coins in a coin selector. This was mentioned for example in the patent document Japanese Laid Open Patent No. 2000-36067 (pages from 3 to 5, FIGS. 2,3,5 and 6) corresponding to the U. S. Pat. No. 6,125,987 (which is incorporated herein by reference). In this prior arrangement a key coin is entered into the coin selector. Subsequently the coin selector is changed to a sampling mode. In the sampling mode, the standard data can be collected. Next, genuine coins of a predetermined number are entered into the coin selector. Accordingly, the data can only be collected by using genuine coins. Therefore the standard data is made up based on the genuine coins data and is set up in a memory means at the coin selector. In the prior art, the standard data was made up based on coins which were received into the coin selector. Accordingly, the standard data was dependant on the assembly precision of the coin selector, and having a highly accurate distinction. Also, the method was limited to a person who has the key coin; for example only a manager can change the standard data with this method. However, such a person has to put in the coins into the coin selector. As a result, the procedure can be troublesome.

For example, when the coins are 20 piece types in number and the coin selector requires 100 units to change the standard data, the operator has to put 2000 coins. Therefore, the changing operation takes a long time. Also, when the coins are put in oriented only with the same facing side (one-side facing the same direction) the resulting standard data is skewed. This leads to a genuine coin being distinguished as false.

### SUMMARY OF THE INVENTION

A primary purpose of this present invention is to provide a coin selector which can be easily set and in which the standard data can be set without putting coins into the coin selector.

Another purpose of this invention is to provide both a coin selector and an outside setting unit which are not easily changed as to the standard data.

As a solution to this problem, this present invention is structured based on the cooperating features as follows: A coin selector comprises a plural standard data memories for memorizing standard data, a selecting means which can be effective to select standard data memory based on a direction from an outside setting unit, a distinguishing means which compares the memorized data of said selected standard data memory and the outputting data of a coin sensor and outputs the authenticity signal, a gate controlling means which controls a gate based on an output from the distinguishing means.

With the structure and system of the invention, the standard data for distinguishing coins are made up by preparations in advance where standard coins are put into a coin selector, and are memorized in the memory. When the setting is changed to a new setting data, the outside setting unit is connected to the coin selector. Next, a new standard data memory is selected by the selecting means. Entry coin data which is detected by a coin sensor is compared to the selected standard data by the distinguishing means, and is distinguished for authenticity. The gate controlling means is controlled based on the authenticity. Therefore the coins are diverted either to a genuine or a false passageway.

The standard data for distinguishing coins are memorized or entered into the plural standard data memories in the coin selector. Also the memorized standard data becomes valid for selection as the occasion demands by an operation. Therefore standard coins are not put into the coin selector to change the standard data. As a result, the standard data can be easily changed.

Also, the standard data which is memorized in the standard memory means can not be changed in an unauthorized manner, and is highly reliable. The operation is to make good use of the memorized standard data and such memorized standard data can be only set up by designated people which can use the outside setting unit. As a result, the standard data is not set up for the gain of non designated or unauthorized individuals. For example, only the manager can have the outside setting unit, and can reset or set up the standard data using the outside setting unit.

This present invention is desirable, because such standard data memory memorizes the standard data from which it is established with the coin sensor based on an entered standard coin into said coin selector. In this structure, the standard data for distinguishing coins are made up or compiled whereby standard coins are put into a coin selector, at another location and in advance such that the data are memorized by the standard data memory. Therefore, the standard data is based on the coin selector's assembly precision or the parts precision. As a result, the distinguishing precision is highly reliable.

This present invention is further desirable because such an outside setting unit and a selecting circuit can be connected up by a cable with a connector, said cable includes a signal line and a power line.

In this structure and system of the invention, when the standard data is changed, the outside setting means and the coin selector are connected by the cable with the connector. The cable with the connector includes the signal line and the power line. Therefore, the outside setting unit is provided with the power from the coin selector. Accordingly, the outside setting unit does not need a power source. As a result, the outside setting unit is small and light weight and is generally convenient to transport.

The present invention is further desirable, because the outer setting unit includes selecting switches for the standard data and a selecting executing switch. In this structure, the standard data is selected from a plurality of memorized standard data which are memorized in plural memory locations (plural memories) of the coin selector by the selecting switches. Next, the selected standard data comes into effect by the selecting executing switch.

Therefore, the standard data becomes valid in two operations which are, by use of the selecting switch and the selecting executing switch. As a result, the changing operation is easier. Also, when the changing operation continues, only the selecting executing switch is operated. As a result, the operation is easier.

The present invention is also desirable because the outer setting unit includes a standard data preparing means on the outer setting unit. In this structure and system according to the invention, newly provided standard data can be set up on the coin selector by entering some new coins. Therefore a new standard data can be set up easier.

The present invention is further more desirable as said outer setting unit includes a adjusting volume indicating means. With this structure, when a new standard data is made up, the sensitivity set for the standard coin can be seen on the adjusting volume indicating means by the operator. Therefore the operator can easily set up the standard data.

This present invention is desirable, because said adjusting volume indicating means provides that the emitting position is changeable together with the adjusting volume. In this structure, when newly standard data is made up, the sensitivity in the standard coin can be seen on the adjusting volume indicating means by the operator. The emitting position on the adjusting volume indicating means is changed based on the sensitivity. Therefore the adjusting operation is easier.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a perspective view of the coin selector and the outside setting unit of a preferred embodiment of the invention embodiment;

FIG. 2 is a block diagram of the coin selector of the embodiment of FIG. 1;

FIG. 3 is a block diagram of the outside setting unit of the embodiment of FIG. 1;

FIG. 4 is a flow chart for setting of the initial standard data of the coin selector of the embodiment of FIG. 1;

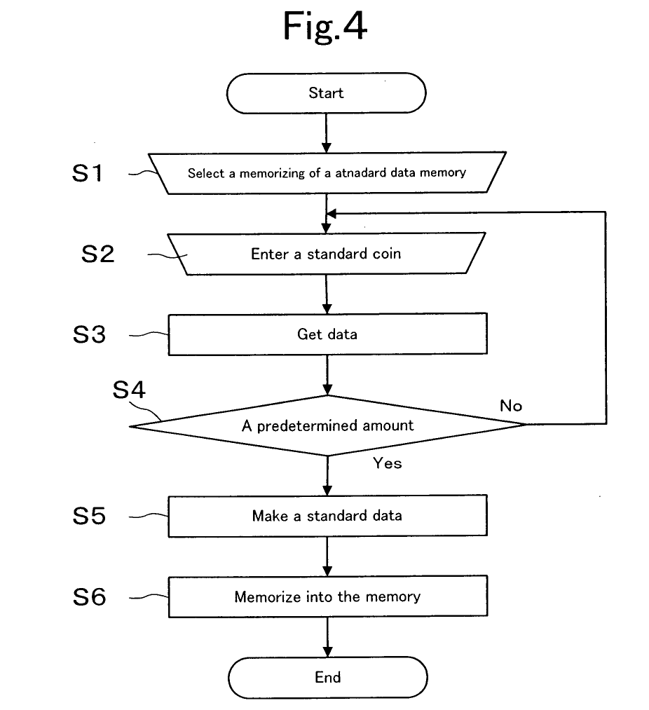

FIG. 5 is a flowchart for selecting of the standard data of the embodiment of FIG. 1 when the coin is changed;

FIG. 6 is a flow chart for explaining of the outside setting unit of the embodiment of FIG. 1.

FIG. 7 is a flow chart for explaining of the coin selector of the embodiment of FIG.

### DESCRIPTION OF THE PREFERRED EMBODIMENT

Referring to the drawings in particular, the structure of a coin selector 1 is firstly explained. A coin selector 1 is box like in shape and is attached into, for example, slot machines or other coin based machines (gamming machines, arcade game machines, vending machines, etc.) and can use a known coin selector; for example the selector known from U.S. Pat. No. 6,056,105 (which is hereby incorporated by reference).

The coin selector 1 includes a mechanical section 4 and an electric section 6. The mechanical section 4 includes a coin passageway 14 which continues to entry slot 12. A gate 16 is located at the lower section of the coin passageway 14 as well as a genuine coin passageway 28 and a false coin passageway 30. The electric section 6 includes coin sensor 20 which detects data for distinguishing passed through coin 18 and selecting circuit 21.

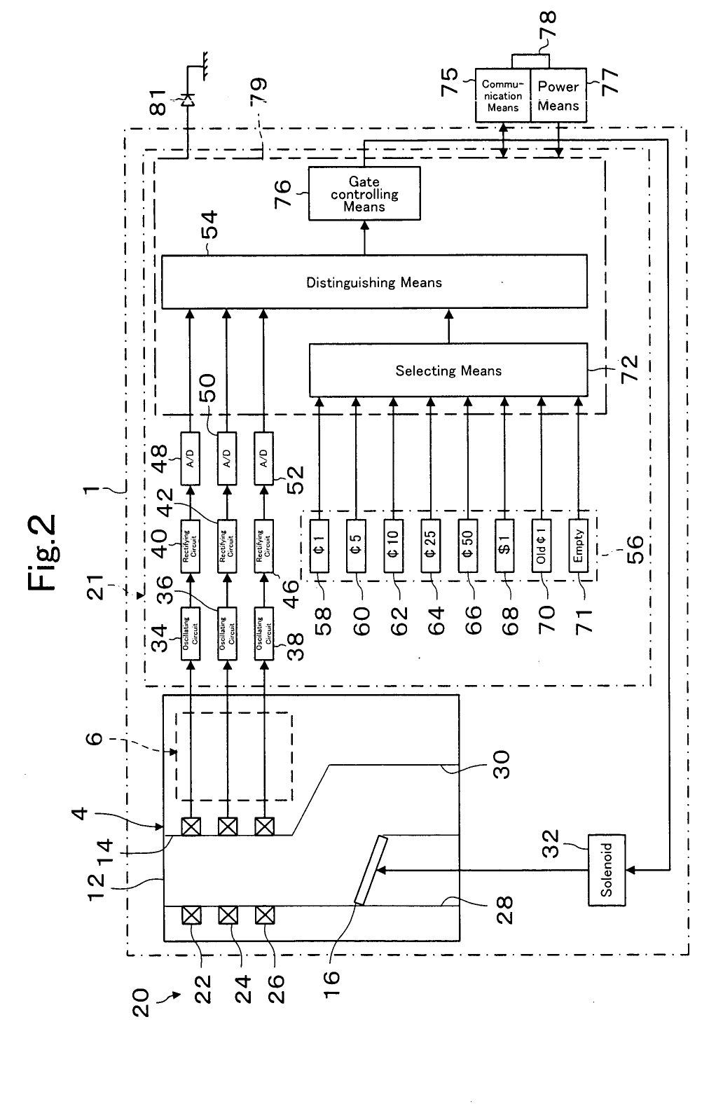

The structure of mechanical section 4 is explained below in particular. A coin passageway 14 has the function such that the coin 18 which entered into entry slot 12 is guided at a predetermined position. The passageway 14 is made up as a slant, a perpendicular (to the entry opening or horizontal) path or a curve. The coin passageway 14 in embodiment of FIG. 2 is a perpendicular path and sensor 20 is located at the upper section thereof. The gate 16 has a function such that the falling coin 18 in coin passageway 14 is diverted to either the genuine passageway 28 or the false passageway 30.

In this embodiment, the gate 16 can go in and out of the coin passageway 14 which is located downstream of the coin sensor 20. When the coin 18 is genuine, the gate 16 is located outside of coin passageway 14. When the coin 18 is false, the gate 16 is located inside of the coin passageway 14. In other words, when the coin is genuine, a solenoid 32 is excited, and the gate 16 is removed to the outside of the coin passageway 14. When the coin is false, the solenoid 32 is not excited, and the gate 16 is kept in coin passageway 14 by a spring (not shown). Accordingly, a false coin which falls in the coin passageway 14 is guided into the false coin passageway 30 by the gate 16, and is returned into a return slot (not shown). A genuine coin is guided into genuine coin passageway 28, and is guided into a safe (not shown) or holding container.

Next, the structure of the electric section 6 is explained. The sensor 20 has a function which detects data (feature data or characteristics data); for example a diameter, a material and a thickness of coin for distinguishing genuine or false coins, and it can be made up by electric, optical, magnetic, etc. sensor elements and combinations thereof The sensor 20 can be selected for only one diameter, material or thickness, however it can use combined or plural parameters. When the plural parameters are selected, the genuineness accuracy becomes highly accurate and this is desirable. In this embodiment, three coils 22,24,26 are positioned around the coin passageway 14, and can detect a diameter, a material and a thickness for distinguishing between fake and genuine coins.

The coils 22,24,26 can be made up around a cylinder core, and may be located adjacent to the coin passageway 14. The coil 22 is used for detecting the diameter data, the coil 24 is used for detecting the material data and coil 26 is used for detecting the thickness data.

Next the selecting circuit 21 is explained. The selecting circuit 21 is fixed at a section which is shown in a dotted line at the side of coin passageway 14. A block diagram of selecting circuit 21 is shown at the right for convenience as shown in FIG. 2. Oscillating circuits 34, 36, 38 are connected to the coils 22,24,26. The oscillating circuit 34 is connected to the distinguishing means 54 through rectifying circuit 40 and A/D converting circuit 48. The oscillating circuit 36 is connected to the distinguishing means 54 through rectifying circuit 42 and A/D converter 50. The oscillating circuit 38 is connected to the distinguishing means 54 through rectifying circuit 46 and A/D converter 52.

Also, there is standard data memory 56 which memorizes standard data for distinguishing coins. In this embodiment, the U. S. coins are used. Therefore, there is a new 1 cent standard data memory 58, a 5 cent standard data memory 60, a 10 cent standard data memory 62, a 25 cent standard data memory 64, a 50 cent standard data memory 66, a 1 dollar standard data memory 68, an old 1 cent standard data memory 70 and standard data memory 71 on board.

The standard data memories 58, 60, 62, 64, 66, 68, 70, 71 memorizes standard data (information as to denominations, and adjusting limits) for distinguishing genuine coins. The denomination information is limited to selected denominations for the process of distinguishing coins as their being genuine. The limited information is a coefficient which adjusts the denomination information for expanding or reducing the number of denominations. These standard data memories are connected to the distinguishing means 54 through the selecting means 72. The selecting means 72 has a function where only one set of standard data, which is selected by the outside setting unit 74 from the standard data memory 58 to 71, is usefully selected.

The distinguishing means 54 has the function of receiving data as to the entered coin 18 from coils 22,24,26 and standard data which is received from selecting means 72. The distinguishing means 54 compares the coin data and the standard data and the authenticity of entered coin 18 is distinguished. Where the data received by the coils are within the limits, the coin is distinguished as genuine, also when the data is not within the limits, the coin is distinguished as false. When the coin 18 that has been fed in is genuine, solenoid 32 is excited at a predetermined time through gate controlling means 76.

A communicating means 75 and power means 77 are also provided as shown in FIG. 2. The communicating means 75 communicates to the outside setting unit 74 for changing standard data memory 56 of selecting means 72. The power means 77 supplies electric power to the block circuit and outside setting circuit 84. Distinguishing means 54, selecting means 72 and gate controlling means 76 are provided via programing in microprocessor 79. A connector 78 connects to the outside communicating circuit 84. The connector 78 is fixed at selecting circuit 21. The circuit 21 is connected to ground through a diode 181.

The connector 78 is located at the valley between coin passageway 14 and attaching flange 80. Accordingly, connector 78 is protected by coin passageway 14 and attaching flange 80. As a result, when coin selector 1 is transported, connector 78 does not receive damage. Also, luminous element 81 is located below connector 78 and indicates a situation or status of selecting circuit 21.

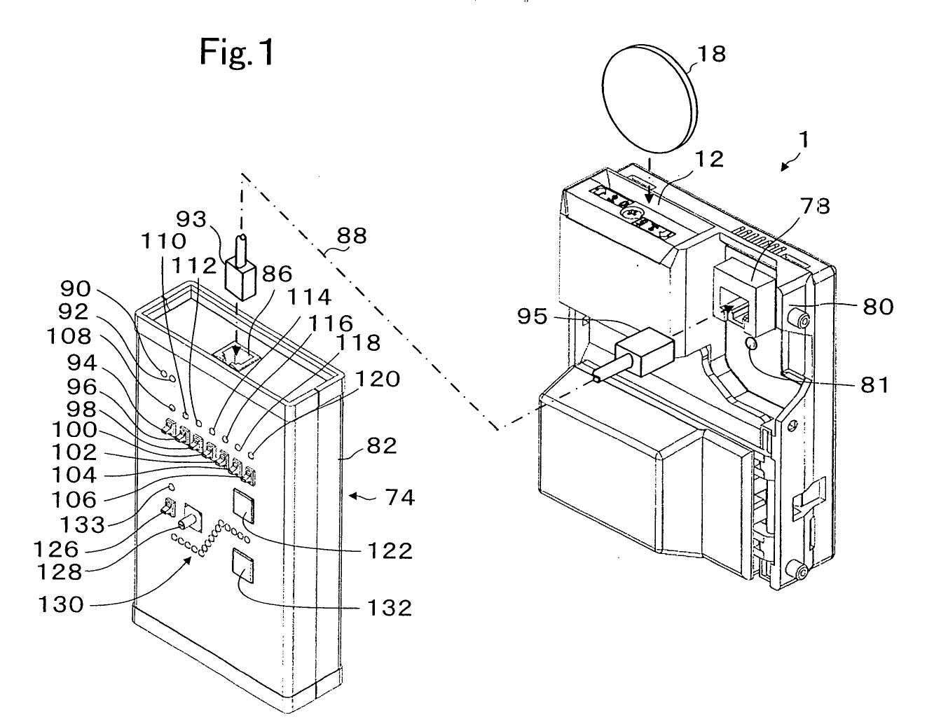

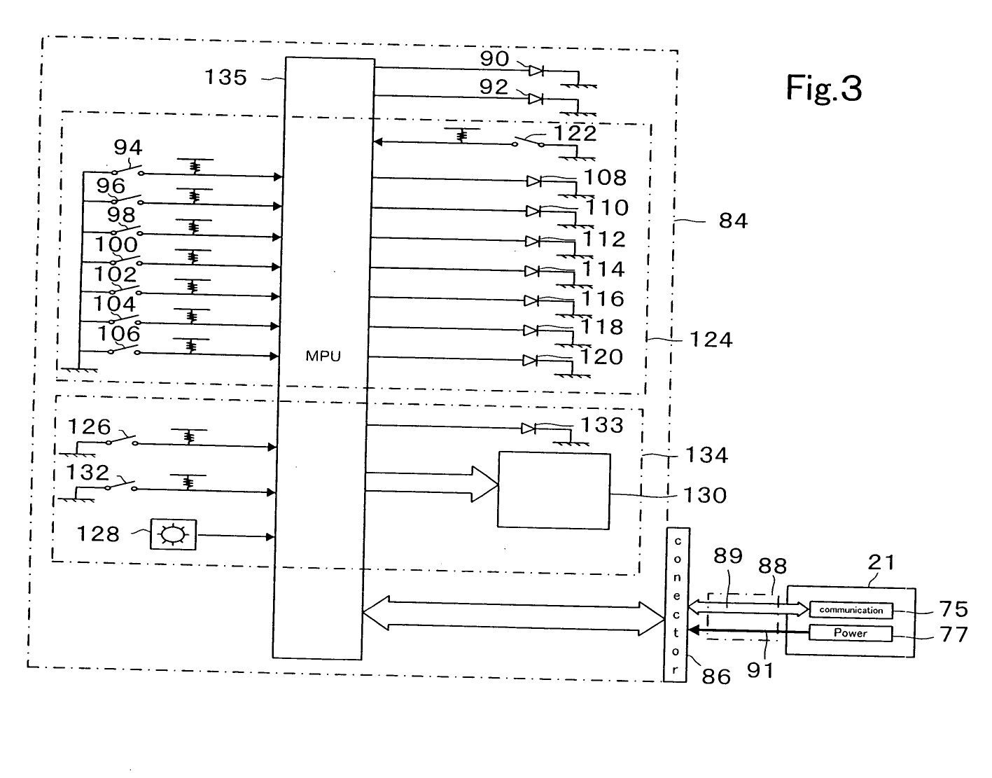

Next, the outside setting unit 74 is explained referring to FIGS. 1 and 3. The outside setting unit 74 includes a box 82 which is a handheld and an outside setting circuit 84 which is built in the box 82. A connector 86 is attached at the outside setting circuit 84 and is connected to the connector 78 of the selecting circuit 21 through a LAN cable 88. The LAN cable 88 includes a signal line 89 and a power line 91. A connector 93, which is located at the end of LAN cable 88, can be detached and attached to the connector 86, and a connector 95 at another end can be detached and attached to the connector 78.

An emitting element 90, for indicating power, is located at the left upper section of the box 82 and emits light when the power is supplied. The emitting element 92 indicates the situation of the selecting circuit 21. The emitting element 92 is located near the right side of emitting element 90 and emits light when the selecting circuit 21 is busy. Selecting switches 94, 96, 98,100,102,104, 106 are provided for setting the denominations. These selecting switches are in a row at a predetermined distance and are located near and below the emitting elements.

Emitting elements 108,110,112,114,116,118,120 are provided for indicating denomination. These emitting elements 108,110,112,114,116,118,120 are located adjacent to and over the switches, and emit light when the denomination is selected. In this embodiment, the switch 94 and the emitting element 108 correspond to the 1 cent coin, the switch 96 and the emitting element 110 correspond to the 5 cent coin, the switch 98 and the emitting element 112 correspond to the 10 cent coin, the switch 100 and the emitting element 114 correspond to the 25 5 cent coin, the switch 102 and the emitting element 116 correspond to the 50 cent coin, the switch 104 and the emitting element 118 correspond to the 1 dollar coin and the switch 106 and the emitting element 120 correspond to the old 1 cent coin.

An executing selecting switch 122 is provided for changing the selected selecting means 72. The executing selecting switch 122 is located near and below selecting switch 104 and 106 and is a push button system. A selecting changing means 124 is made up by the emitting elements 108,110,112,114,116,118,120 for indicating the selected denomination, the selecting switches 94,96,98,100,102,104,106 and the executing selecting switch 122. An on board setting switch 126 which is a toggle system, a digital rotary switch 128, an adjusting amount indicating means 130 and an on board executing setting switch 132 are located in a row and below the executing selecting switch 122.

The adjusting amount indicating means 130 includes 15 emitting elements which are positioned side by side to form a crank-like shape. The standard emitting element is located at the middle. When the amount of the digital rotary switch 128 is higher than a standard amount, an emitting element, at the right side to the middle, lights as shown in FIG. 1. When the amount is lower than the standard amount, an emitting element at the left side to the middle, lights. The emitting element 133 for indicating the on board setting mode is located adjacent to and above the on board setting switch 126. The on board standard setting means 134 is made up by the on board setting switch 126, the on board executing setting switch 132, the digital rotary switch 128 and the on board setting mode indicating emitting element 133.

The outside setting circuit 84 is made up by a microprocessor 135, the emitting elements 90,92, the selecting switches 94,96,98,100,102,104,106, the executing selecting switch 122, the emitting elements 108,110,112,114,116,118,120, the on board setting switch 126, the digital rotary switch 128, the adjusting amount indicating means 130, the on board executing setting switch 132 and the emitting element 133 for indicating on board setting mode as shown in FIG. 3. Also, the emitting element is a LED (light-emitting diode) and it is desirable from the point of view, for example; of it being miniature, of it having low amounts of power consumption and being low in cost. Also, the emitting element can be changed to another indicating means.

Next, the operation of this embodiment is explained. Firstly, an initial setting process at the time of a shipment is explained. An initial setting unit (not shown) which is structured in the same manner as outside setting unit 74 is connected to selecting circuit 21 through the LAN cable 88. In step S1, selecting switch 94 is turned to “ON”, and standard data memory 58 corresponding to 1 cent is selected.

Next, in step S2, a standard 1 cent coin is entered into entry slot 2. In step S3, the standard 1 cent coin data is received. In other words, an eddy current occurs in the coin 18. Accordingly, the oscillations of coils 22,24, 26 are changed by the eddy current. In other words, the oscillating circuit 34 connected to coil 22 provides the current to the rectifying circuit 40 which corresponds to the diameter of coin 18. The oscillating circuit 42 connecting to coil 24 provides the current to the rectifying circuit 42 which corresponds to the metal of coin 18. The oscillating circuit 38 connecting to the coil 26 provides the current to rectifying circuit 46 which corresponds to the thickness of coin 18.

The rectifying circuits 40,42,46 rectify the currents, and afterwards they supply the rectified currents to AD converters 48,50,52. The AD converters 48,50,52 convert from the analog signal to a digital signal. Next in step S4, the received data is distinguished to correspond to a predetermined quantity; for example 10. When the quantity does not satisfy 10, the program returns to step S2. When the quantity corresponds to 10, the program goes to step S5. In step S5, the received data which is referring to the diameter of the coin, the metal and the thickness are processed at a predetermined process. Then, the standard data of the 1 cent coin is formed or made up.

In step S6, the made up standard data referring to the 1 cent coin is memorized or stored into memory 58. Therefore, in the initial setting process, the standard data includes an acceptable error with regard to variations in manufacturing the coin passageway 14 and coils 22, 24,26.

Next, memorizing circuit 60 for the 5 cent coin is selected and is turned on. Afterwards, the standard data is memorized in memorizing circuit 60 in the same manner as the above-mentioned for the 1 cent coin. As the same as the above-mentioned, the standard data for the 10 cent coin, the 25 cent coin, the 50 cent coin, the 1 dollar coin and the old 1 cent coin are made up, and are memorized in corresponding to the memories. Afterwards, coin selector 1 is sent to an owner/operator. In this embodiment, the standard data corresponds to 7 denominations; however it can be changed at will.

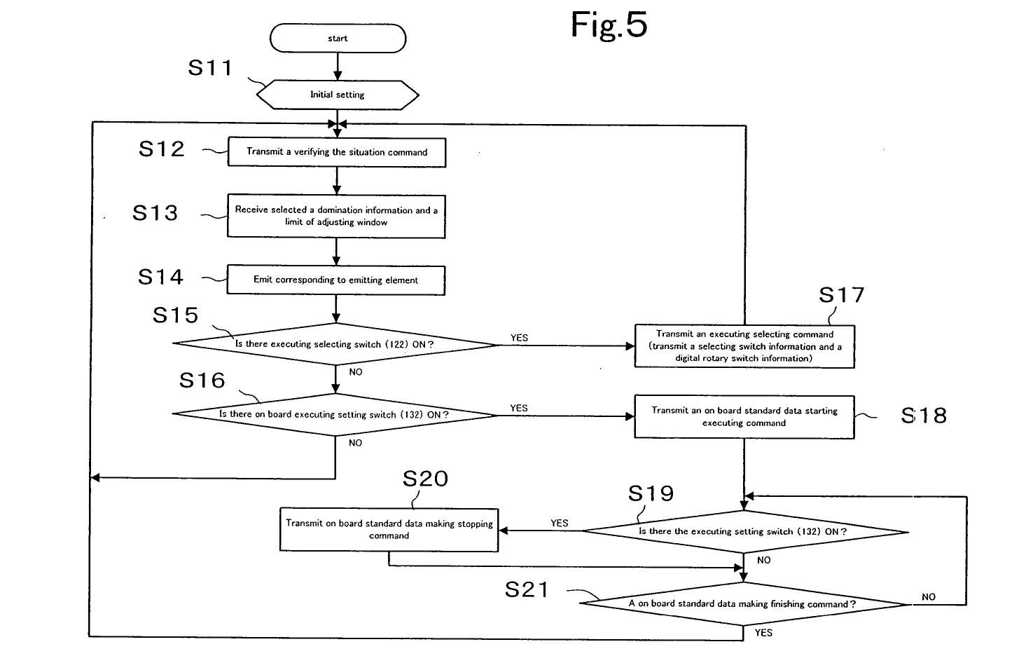

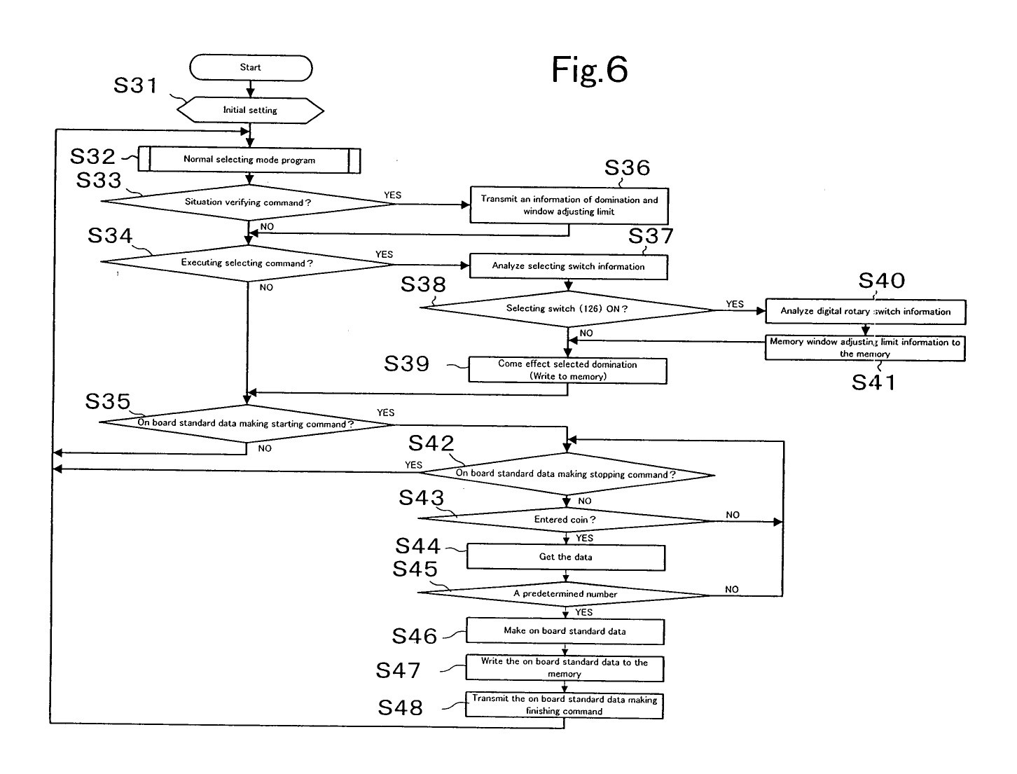

The owner/operator attaches the coin selector 1 to a slot machine or other coin machine. Afterwards, the receiving denomination is set by the owner. The setting process is explained referring to FIGS. 5 and 6. Firstly, the connector 93 of the LAN cable 88 is inserted into the connector 86 of outside setting circuit 84 and another connector 95 is inserted into the connector 78 of the coin selector 1.

Therefore, power is supplied to the outside setting circuit 84 through the power line 91. The outside setting circuit 84 starts the process, then the emitting element 90 for indicating the power emits light. In step S11, the outside setting circuit 84 initializes the microprocessor 135, and the program goes to the step S12. In step S12, a command for identifying the situation is outputted to the selecting circuit 21. In step S31 based on the power in the selecting circuit 21, the microprocessor 79 is initialized, afterwards the program goes to step S32. In step S32, the normal selecting mode program starts. In other words, when the coin 18 is entered into the entry slot 12, the after-mentioned authenticity program is executed, and the coin 18 is distinguished. When the coin 18 does not enter, the program goes to step S33, a situation identifying command which is outputted by the outside setting circuit 84 is distinguished. When the situation identifying command is not distinguished, the program goes to step S34. In step S34, the executing selecting command which is outputted by the outside setting unit 74 is distinguished. When the executing selecting command is not distinguished, the program goes to step S35.

In step S35, the on board standard data making command which is outputted by outside setting unit 74 is distinguished. When the on board standard data making command is not distinguished, the program returns to step S32. In other words, when a coin is not entered and each of the executing switches are not operated (not ON), the program of selector circuit 21 loops from step S32 to S35. In step S33, the situation identifying command is distinguished at step S12, and the program goes to step S36.

In step S36, “information of selecting denomination ” and “information of adjusting limit ” which are set up in the selecting circuit 21 are transmitted to the outside setting circuit 84. In step S13, when the outside setting circuit 84 receives the information, the program goes to step S14. The emitting element corresponding to the denomination which was selected from emitting element 108 to 120 is emitted. Also, the emitting element corresponding to the limit which was selected based on the information of the adjusting limit is emitted. When the information is not installed, the emitting elements do not emit.

In this case, the emitting elements do not emit, because the information of selected denomination and the information of the adjusting limit is not set up. In step S15, “ON” of executing selecting switch 122 is distinguished. When it is “OFF”, the program goes to step S16. In step S16, “ON” of on board executing selecting switch 132 is distinguished. When it is “OFF”, the program returns to step S12. In other words, when each executing switch is not operated, the program in the outside setting circuit 84 loops from step S12 to S16. When the denomination is changed, a predetermined switch goes to “ON”. For example, where the selecting switch 100 corresponding to the 25 cent coin is “ON”, next the executing selecting switch 122 is pushed. In this situation, the executing selecting switch 122 is “ON” in step S15, therefore the program goes to step S17. In step S17, the executing selecting command which includes the information of denomination and adjusting limit of selecting switch 100 is outputted to selecting circuit 21.

When selecting circuit 21 distinguishes the executing selecting command in step S34, the program goes to step S37. In step S37, the information as to the denomination (25 cent in this embodiment) and the adjusting limit (a median in this embodiment) is analyzed, afterwards the program goes to step S38. In step S38, when selecting switch 126 is not “ON”, the program goes to step S39. In step S39, the standard data (information of denomination and adjusting limit) of 25 cent which is memorized on standard data memory 64 becomes valid, afterwards the program goes to step S35.

In step S35, when the on board standard data starting command is distinguished, the program returns to step S32, afterwards the program goes from step S33 to step S36. In this process, the valid information of denomination and adjusting limit is transmitted to outside setting circuit 84. The outside setting circuit 84 receives the information, afterwards in step S14, the emitting element 114 corresponding to the information emits and the emitting element of the adjusting limit indicating means 130 corresponding to the information emits.

Next, the situation where standard data was not memorized in the standard data memory 58 to 70 is explained. For example there is a case where new tokens are used in a slot machine or in a vending machine or game machine. In other words, the process where the standard data for distinguishing a new token or coin is to be memorized or saved to the on board standard data memory 71 is explained below.

Firstly, as above-mentioned, connector 95 of LAN cable 88 is inserted into connector 78 of coin selector 1. Therefore power is supplied to the outside setting circuit 84. The outside setting circuit 84 starts the process, then emitting element 90 for indicating the power emits light. When on board executing setting switch 132 is pushed and becomes “ON”, the program goes from step S16 to step S18.

In step S18, the program in the outside setting circuit 84 outputs an on board standard data making starting command to selecting circuit 21. Afterwards the program goes to step S19. In step S19, when “ON” of the on board executing setting switch 132 is detected again, the program goes to step S20. In step S20, the command for stopping the making of the on board standard data is transmitted to coin selecting circuit 21.

When the on board executing setting switch 132 is not pushed, the program goes to step S21. In step S21, the finishing command for making the on board standard data is distinguished. When the finishing command is distinguished, the program returns to step S12. When the finishing command is not distinguished, the program returns to step S19. When the selecting circuit 21 receives the starting command for making the on board standard data in the selecting circuit 21, the program goes from step S35 to step S42.

In step S42, when the stopping command for making on board standard data is not distinguished, the program goes to step S43. When on board executing setting switch 132 is pushed again; in other words, when the stopping command is received, the program returns to step S32. In step S43, when coin 18 is distinguished, the program goes to step S44. In step S43, when coin 18 is not distinguished, the program returns to step S42.

Next, in step S43, when a new coin is distinguished, the program goes to step S44. In step S44, the data which is received from coils 22,24,26 are memorized in the internal memory of microprocessor 134 through oscillating circuits 34,36,38, rectifying circuit 40,42,46 and AD converter 48,50, 52 as above-mentioned. Next, in step S45, the number of times of sampling or getting the data is distinguished. The number of times of receiving or getting the data is set up beforehand; for example it is desirable to sample or get from 10 to 20 times from the point of view of ensuring that the operation is reliable. In this embodiment, it is set up at 10 times.

In this case, it is first time, the program returns to step S42. When the data is received 10 times, the program goes to step S46. In step S46, a predetermined process is executed based on the received data, and a new standard data (information of denomination) is made up, and the program goes to step S47. In step S47, the new standard data is memorized in standard data memory 71, and the program goes to step S48.

In step S48, a finishing command for sending on board is outputted to outside setting circuit 84. In step S21 in the outside setting circuit 84, when the finishing command is distinguished, the program returns to step S12, afterwards the program goes to the standby situation.

When the adjusting limit of newly setting standard data is adjusted, on board setting switch 126 is turned on, afterwards executing selecting switch 122 is pushed. Accordingly, the program in selecting circuit 21 goes from S34 to S37, the information of the denomination and the adjusting limit of the standard data memory 71 is analyzed. The denomination information of the newly installed standard data is analyzed, however the adjusting limit information is not memorized. Next, in step S38, selecting switch 126 is turned on, therefore the program goes to step S40.

In step S40, the setting information of the digital rotary switch 128 is analyzed, afterwards the program goes to step S41. In step S41, the setting data of digital rotary switch is memorized in the standard data memory 71, and the program returns to step S39. In step S39, the standard data which is analyzed in step S37 is set up, afterwards the program returns to step S35.

Therefore the digital rotary switch 128 is adjusted to a predetermined amount, afterwards the executing selecting switch 122 is pushed. As a result, the adjusting limit can be adjusted. In step S14 in the outside setting circuit 84, the emitting element 133 which is the newly set up denomination and the emitting element of the adjusting limit emitting element 130 corresponding to new adjusting limit are emitted.

Also, the situation indicating emitting element 92 of the outside setting unit 74 indicates a situation of the microprocessor 79 of the selecting circuit 21. For example, when the microprocessor is busy, the emitting element emits. When the setting of many slot machines (or vending machines, gaming machines, arcade machines) are continuously changed to 25 cent, selecting switch 100 is continuously turned on, and connector 95 of LAN cable 88 is pulled out, afterwards the connector 95 is inserted into connector 78 of next coin selector 1.

Therefore, the power is supplied to the outside setting circuit 84, and the emitting element 90 for indicating power emits. In step S15, when executing selecting switch 122 is turned on, the program goes to step S27 in selecting circuit 21 as the same as above-mentioned. Therefore the information of denomination and adjusting limit of selecting switch 100 which is turned on is analyzed. Next, in step S38, selecting switch 126 is turned off, and the program goes to step S39. In step S39, the standard data memory 64 corresponding to analyzed 25 cent becomes effective. In the other slot machines (or other coin machines), the operation is operated in the same manner as above-mentioned. As a result, the slot machines (or other coin machines) are changed to the same denomination.

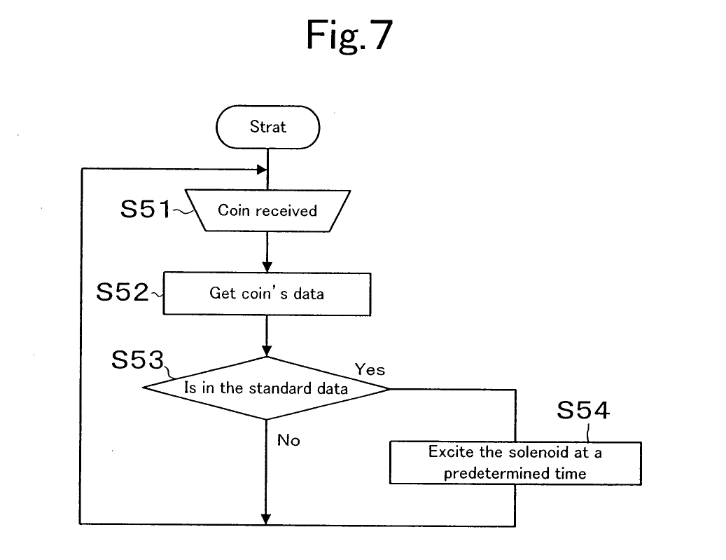

Next, the distinguishing of the authenticity based on a setting as above-mentioned of the entered coin is explained referring to a flow-chart in FIG. 7. Firstly, in step S51, a coin 18 is entered. In step S52, data referring to a diameter, a metal type and a thickness are received by coils 22,24,26.

Next, in step S53, the received data is compared with the standard data of the standard data memory which is selected and which came into effect, for example 25 cent which is memorized in memory 64. When the received data is outside of the standard data, in other words, when the coin is false, the program goes to step S51. Therefore, gate 16 is continuously located at coin passageway 14, the false coin 18 is diverted to the side by gate 16, and goes to false passageway 30.

When received data is within the standard data; in other words, when the entered coin is genuine, the program goes to step S54, the solenoid 32 is excited at a predetermined time by the gate controlling means 76. Therefore, gate 16 goes out from coin passageway 14, and coin 18 can fall, then the coin 18 goes to the genuine passageway 28, and it is stored in the safe.

According to the present invention, the standard data for distinguishing a coin is memorized in the standard data memory. Also, one set of the standard data comes into effect as the need arises by appropriate selection. Therefore, entering standard coins on the selector is not needed. As a result, the standard data can be easily changed. Also, the standard data which is memorized in the memory comes into effect. In other words, the standard data is not newly communicated. As a result, the reliability of the standard data is higher.

Putting the memorized standard data into effect can be done by only one person which has the outside setting unit. For example, a limited number of persons have the outside setting unit. As a result, the standard data can be changed by the limited number of persons. Also, the standard data for distinguishing coins is made up by entering the standard coins into the coin selector beforehand, and is memorized in the memory. Therefore the standard data is based on the coin selector's assembly precision or the parts precision. As a result, the distinguishing precision is higher.

Also, the outside setting unit is miniature and lightweight, because the outside setting unit does not have a power source. The changing of the standard data is easier, because only the selecting switch for the standard data and the executing selecting switch are operated.

The new standard data can be set up on the coin selector by entering new coins. Therefore new standard data can be set up easier. Also, when new standard data is made up, the sensitivity in the standard coin can be seen on the adjusting volume indicating means by the operator. Therefore the adjusting operation is easier.

While a specific embodiment of the invention has been shown and described in detail to illustrate the application of the principles of the invention, it will be understood that the invention may be embodied otherwise without departing from such principles.

What is claimed is:

1. A coin selector comprising:
a coin slot with a gate
a coin sensor;
an outer setting unit;
plural standard data memory locations for memorizing standard data;
a selecting means to effectively select standard data memory based on a command from said outer setting unit;
a distinguishing means for comparing memorized data of the selected standard data memory and the output data of said coin sensor and provides an output of an authenticity signal; and
a gate controlling means which controls said gate based on said output from said distinguishing means.

2. The coin selector as claimed in claim 1, wherein said standard data memory memorizes standard data from said coin sensor based on an entered standard coin into the coin selector.

3. The coin selector as claimed in claim 1, further comprising a cable with a connector wherein said outside setting unit and a selecting circuit that includes said selecting means are adapted to be connected up by said cable with said connector, said cable including a signal line and a power line.

4. The coin selector as claimed in claim in claim 2, wherein said outer setting unit includes selecting switches for said standard data and a selecting executing switch.

5. The coin selector as claimed in claim 4, wherein said outer setting unit includes a standard data preparing means on said outer setting unit.

6. The coin selector as claimed in claim 5, wherein said outer setting unit includes an adjusting volume indicating means.

7. A coin selector system comprising:
a coin selector module with a coin slot with a gate, a coin sensor for sensing coins passing through said coin slot, memory means for providing a plurality of standard data memory locations for memorizing standard data, a selecting means for selecting standard data memory, a distinguishing means for comparing memorized data of the selected standard data memory and the output data of said coin sensor and providing an output of an authenticity signal and a gate controlling means which controls said gate based on said output from said distinguishing means; and
an outer setting unit separate from said coin selector module, said selecting means selecting one or more of said standard data memory locations based on a command from said outer setting unit.

8. The coin selector system as claimed in claim 7, wherein said standard data memory memorizes standard data from said coin sensor based on an entered standard coin into the coin selector.

9. The coin selector system as claimed in claim 7, further comprising a cable with a connector wherein said outside setting unit and a selecting circuit that includes said selecting means are connected up by said cable with said connector, said cable including a signal line and a power line.

10. The coin selector system as claimed in claim in claim 8, wherein said outer setting unit includes selecting switches for said standard data and a selecting executing switch.

11. The coin selector system as claimed in claim 10, wherein said outer setting unit includes a standard data preparing means on said outer setting unit.

12. The coin selector as claimed in claim 11, wherein said outer setting unit includes an adjusting volume indicating means.

13. An outer setting unit for a coin selector having a coin passage with a gate, a coin sensor for sensing coins, a memory for storing plural sets of standard data, a selecting circuit for selecting one or more sets of standard data, a distinguishing device comparing memorized data with the output of said coin sensor and providing an authenticity signal and a gate controlling means which controls said gate based on the an authenticity signal, said outer setting unit comprising:
an outer setting unit assembly separate from said coin selector, said outer setting unit assembly having a communication means for communicating with said selecting means selecting one or more of said standard data memory locations based on a command from said outer setting unit.

14. An outer setting unit as claimed in claim 13, wherein said standard data memory memorizes standard data from said coin sensor based on an entered standard coin into the coin selector.

15. An outer setting unit as claimed in claim 13, further comprising a cable with a connector wherein the outside setting unit and said selecting circuit are adapted to be connected up by said cable with said connector, said cable including a signal line and a power line to power the outer setting unit.

16. An outer setting unit as claimed in claim in claim 14, further comprising: selecting switches for said standard data and a selecting executing switch.

17. An outer setting unit as claimed in claim 16, further comprising a standard data preparing means on the outer setting unit.

18. An outer setting unit as claimed in claim 17, further comprising; an adjusting volume indicating means.
